(19) United States
(12) Patent Application Publication
(10) Pub. No.: US 2007/0249365 A1
(43) Pub. Date: Oct. 25, 2007

(54) DEVICE, METHOD AND COMPUTER PROGRAM FOR CONNECTING A MOBILE DEVICE TO A WIRELESS NETWORK

(75) Inventor: Magnus Jendbro, Staffanstorp (SE)

Correspondence Address: ALBIHNS STOCKHOLM AB, BOX 5581, LINNEGATAN 2, SE-114 85 STOCKHOLM; SWEDENn, STOCKHOLM, SE

(73) Assignee: Sony Ericsson Mobile Communications AB, Lund (SE)

(21) Appl. No.: 11/381,152

(22) Filed: May 2, 2006

Related U.S. Application Data
(60) Provisional application No. 60/745,192, filed on Apr. 20, 2006.

(51) Int. Cl. H04Q 7/20

(52) U.S. Cl. 455/456.1

(57) ABSTRACT

A solution for a mobile communications device, for controlling connection to a communications network. The invention involves positioning of the mobile device based on received positioning information signals, and comparison of a determined current position for the device with stored position data. If the determined position matches stored position data, a profile related to that position data is selected. The profile comprises settings usable for connection to a communications network. The determined position identifies the profile to use, and when an application involving connection to a network is initiated by a user, the appropriate client and related settings are automatically used.

### FIELD OF THE INVENTION

The present invention relates to the field of mobile communications, and in particular to the procedure of setting up a wireless communication connection between a mobile device and a communications network. More specifically, the invention relates to matching of position data for automatic selection of a profile for setting up such a connection.

### BACKGROUND OF THE INVENTION

Today, a significant penetration of WLANs and VoIP systems has occurred both in homes and offices. VoIP enables the convergence of data and voice networks, allowing network administrators of major corporations or home users to cut costs. At the same time residential gateways provide a mechanism for data WLAN connectivity. Most WLAN usage is for data applications in devices, such as mobile phones, printers, cameras and WLAN IP phones. In general, security issues surrounding WLAN apply to all devices that connect to it, in order to guarantee that trusted relationships are achieved between communicating devices and to prevent eavesdropping of radio signals.

The 802.11i standard enables support for both packet and authentication security. Previous generations of 802.11 security methods revolved around the WEP protocol. The authentication provided by WEP does not provide two-way authentication, i.e. the user does not authenticate the network. The 802.11i standard addresses security deficiencies of WEP using wireless protected access (WPA) and the ratified 802.11i specification has been adopted as WPA2, WPA2 enhances WPA by using the Advanced Encryption Standard, AES, instead of the cipher method RC4 as the encryption engine, 802.11i also discloses a new robust security network (RSN) that may require hardware changes.

Referring to the WLAN security setup, WLAN IP phones provide the ability for a user to pick up their “home” phone and use the same phone anywhere were access to a broadband network is available. Thus, security measures need to encompass these use cases in addition to the traditional security setup. The type of security offered is typically limited to setting up an access point and a device connected to a computer or multiple computers.

802.11i provides for two different types of authentication mechanisms, pre-shared key (PSK) mode and 802.1x-based authentication mode. PSK is essentially a user setup that replaces the pairwise master key (PMK) that would have been exchanged via the 802.1x mechanism. Most ease-of-use implementations for home networks use the PSK mode as the core of their framework.

WLAN IP phones are network devices that normally use network-based authentication_{[24]}. The type of messaging passed between elements is governed by the extensible authentication protocol (EAP). This messaging describes an authentication method using request and response sequences. There are different types of content formats that can be implemented, such as TLS, TTLS and SIM. The purpose of 802.1x in an 802.11i context is to exchange a PMK used to setup a secure network between the access point and the end station.

In the present and near future a WLAN user will need to access different WLAN networks and these different networks will need both different applications as well as different security measures in order to work in a secure and proper manner, as it is disclosed above. A user may e.g. need to use one kind of VoIP client in the home or in a public hotspot environment and a completely different VoIP client at work. Different application may require the user to authenticate the usage by using a VPN client at the office that is not required in home or in the hot spot environment or vice versa.

WO-A1-2005/109934, discloses a method to facilitate the selection of a WLAN, wherein the selection is based on an order of preference. The order of preference is based on the positioning of the mobile node. The position of the mobile node is determined based on e.g. the country code received from a cellular network. The main object of the method is to select a WLAN out of a plurality of available WLAN's based on the country wherein the mobile is used.

US, A1, 20050190747 discloses a mobile phone that is capable of acting differently depending on the place where the mobile phone is used. When the mobile phone is at home the phone receives calls via the home number and when the mobile phone is at work it receives calls to the office. When the mobile phone detects a public hot spot the wireless VoIP is used. From the WLAN detected a profile associated with the detected WLAN, and stored in the mobile phone, is used. The place where the mobile device is used is based on the identity of the WLAN. However, this method requires the mobile device to always scan and search for available wireless networks to set up a connection for communication over said wireless network and, this continuously scanning result in an excessive drainage of the battery of the mobile device.

A general objective of the invention is to provide a solution for mobile devices which provides easy and quick selection of settings to use when connecting to a network with a certain application.

An aspect of this object is to provide a solution which ensures that proper security procedures for different applications are used in the connection process.

Yet another aspect of this object is to provide a solution which does not entail excessive drainage of a battery of the wireless communications device.

### SUMMARY OF THE INVENTION

The present invention relates to a device, as well as a method and a computer program product for use in a mobile device, for controlling connection to a communications network. More specifically, the invention involves positioning of the mobile device, and comparison of a determined current position with stored position data. If the determined position matches stored position data, a profile related to that position data is selected, which profile comprises settings for connection to the network Preferably, selection of a certain profile and launching of a related client works automatically when an application is initiated by a user. This means less user interaction, while appropriate settings may still be employed for different scenarios, typically for different applications and at different positions. Furthermore, the mobile device does not have to scan for wireless networks to connect to, since the network and settings to use are predefined and linked to the position and the type of application initiated. Hence, the battery drainage of the mobile device is reduced and battery time is extended_{[25]}. Another benefit is that it is quicker to find networks since a scanning is not needed. Getting a position is faster than performing a network scan.

According to a first aspect, the invention relates to a mobile device wirelessly connectable to a communications network, comprising a signal transceiver configured to receive positioning information relating to the position of the mobile device; a memory for storing a plurality of position data and profiles related to the position data, which profiles comprise parameters usable for connecting to communications networks; and a control unit configured to compare a current position for the mobile device with stored position data, and to select one of the plurality of profiles to connect to said network if the current position matches stored position data.

In one embodiment the parameters of a profile comprise application clients, and the control unit is configured to launch the application client contained_{[26]} in the selected profile.

In one embodiment the mobile device comprises a user interface operable to initiate an application, wherein the control unit is configured to retrieve parameters comprised in the profile related to the initiated application.

In one embodiment the application clients include VoIP clients and/or email clients, synchronisation clients, browser clients and the like.

In one embodiment the parameters of a profile comprise access parameters.

In one embodiment the access parameters include security parameters and authentication procedures.

In one embodiment the signal transceiver is configured to receive positioning information from a cellular network.

In one embodiment the signal transceiver is configured to receive positioning information from a satellite positioning system.

In one embodiment the communications network is a radio communications network.

In one embodiment the mobile device comprises a user interface operable to manually launch an application client for connection to a communications network, wherein the control unit is configured to store a profile in the memory including parameters used for connecting to the communications networks, responsive to manual launching of an application client.

According to a second aspect, the invention relates to a method for setting up a connection between a mobile device and a communications network, comprising the steps of:
determining the position of the mobile device;
comparing the determined position with position data stored in the mobile device;
selecting a profile related to position data that matches the determined position; and connecting to a communications network using parameters related to the selected profile.

In one embodiment the method further comprises:
selecting an application in the mobile device; and wherein the connecting step further comprises launching an application client related to the selected profile and corresponding to the selected application.

In one embodiment the application clients include VoIP clients and/or email clients_{[28]}, synchronisation clients, browser clients, media player clients, and the like.

In one embodiment the step of determining position comprises receiving positioning information from a cellular network.

In one embodiment the step of determining position comprises receiving positioning information from a satellite positioning system.

In one embodiment the step of connecting further comprises authenticating the connection using a security procedure related to the selected profile.

According to a third aspect, the invention relates to a computer program product for use in a processor system of a mobile device, comprising computer program code executable to:
determine the position of the mobile device;
compare said determined position with position data stored in the mobile device;
select a profile related to stored position data that matches the determined position; and
connect to a communications network using settings related to the selected profile.

In one embodiment the computer program product comprises computer program code executable to:
select an application in the mobile device; and wherein the connecting step further comprises launching an application client related to the selected profile and corresponding to the selected application.

In one embodiment the application clients include VoIP clients and/or email clients, synchronisation clients, browser clients and the like.

In one embodiment the step of determining position comprises receiving positioning information from a cellular network.

In one embodiment the step of determining position comprises receiving positioning information from a satellite positioning system.

In one embodiment the step of connecting further comprises authenticating the connection using a security procedure related to the selected profile.

The subject matter of the different embodiments outlined above may be combined in further embodiments.

### BRIEF DESCRIPTION OF THE DRAWINGS

The features and advantages of the present invention will be more apparent from the following description of the invention with references to the accompanying drawings, on which:

FIG. 1 schematically illustrates an embodiment of a mobile communications device according to the present invention;

FIG. 2 schematically illustrates a method according to an embodiment of the invention in a block diagram;

FIG. 3 illustrates a schematic diagram of a mobile device used in an office network according to an embodiment of the invention; and

FIG. 4 schematically illustrates a way of storing different profiles in a memory of a mobile device according to an embodiment of the present invention.

### DETAILED DESCRIPTION OF EMBODIMENTS OF THE INVENTION

Embodiments of the present invention will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

The present invention is described below with reference to block diagrams and/or flowchart illustrations of methods, apparatus (systems) and/or computer program products according to embodiments of the invention. It is understood that several blocks of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The present invention is described herein as employed in and with a wireless communications device, also denoted a mobile device. In the context of the invention, the mobile device may e.g. be a mobile phone, a PDA (Personal Digital Assistant) or any other type of portable device such as laptop computer.

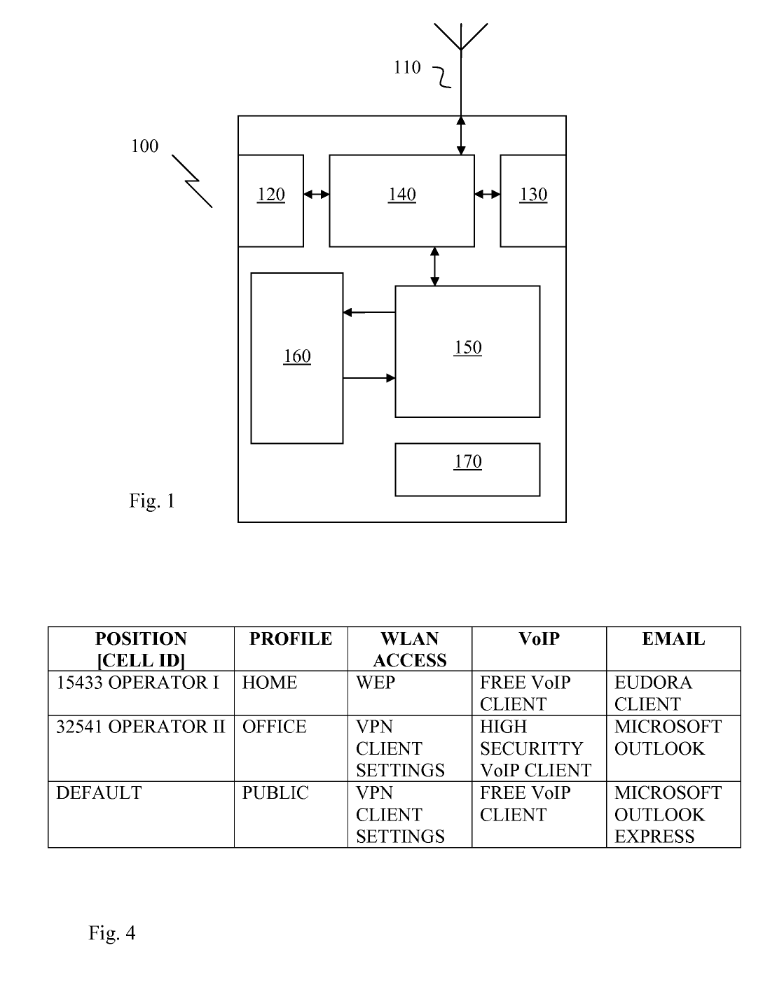

Referring to FIG. 1, a mobile device 100 is disclosed. The mobile device 100 includes an antenna 110 which in one embodiment of the present invention is a combined GSM and GPS antenna or a UMTS and GPS antenna. However, it should be understood that mobile device 100 may be equipped with separated antennas such as a GPS antenna and a GSM antenna or just one type of antenna such as an UMTS, GSM, EDGE, GPRS, CSD antenna or the like. In any case, device 100 is configured, by means of antenna 110, to receive wireless signals comprising position data relating to the position of the mobile device 100 itself. The antenna 110 in the illustrated embodiment is a solid external antenna but it should be noted that the antenna may as well be an extendable antenna or an internal antenna. Antenna 110 is connected to a signal transceiver 140, and is configured to receive wireless information including positioning information either from a cellular network or through the satellite positioning system. A control unit 150 typically includes a central processing unit CPU with associated memory and software, and is configured to control the processes carried out within the device 100. Signal transceiver 140 is connected to control unit 150, inter alia for communication of positioning information received by means of antenna 110. The positioning information received in the device may be in the form of data which needs to be analyzed to determine the related position, as will be explained. In such a case, control unit 150 is configured to establish the position of the device 100 based on the positioning information. Alternatively, the positioning information received may be given directly in the form of position coordinates.

In an embodiment of the present invention the position of the mobile device 100 is defined and identified by the longitude, latitude and altitude coordinate system, expressing the position in spatial terms. Latitude is expressed as 0-90 degrees north or south of the equator and longitude as 0-180 degrees east or west of the prime meridian. Altitude is expressed in meters above sea level. In one embodiment, the positioning information received in mobile device 100 is already in the form of such position coordinates. As an alternative, the positioning data received may be expressed as a text description.

There are different ways of positioning a mobile device, and in one embodiment of the present invention the mobile device is positioned using the mobile phone network within which the mobile device 110 is configured to communicate. One basic positioning procedure is to use the current cell ID. The cell ID is used to identify the base transceiver station, BTS, that the mobile device is communicating with, and the location of the BTS. The accuracy of this positioning method is dependent on the size of the cell and it should be understood that the cell size in a networks varies between 2 to 20 kilometres in diameter. Other techniques for positioning in a cellular network along with cell ID can be employed to narrow the resolution, such as Time Of Arrival (TOA), Time Difference Of Arrival (TDOA) and Angle of Arrival (AOA) techniques. Furthermore, Enhanced Observed Time Difference (E-OTD) is a positioning technology based on software within wireless phones combined with their existing signal measurement capabilities. Today, a position accuracy within 150 meters can be obtained.

In another embodiment of the present invention mobile device is positioned using satellites. Through the Global Positioning System (GPS) the mobile device may be positioned in longitude and latitude. A satellite positioning system is potentially the most accurate method, but requires additional hardware and/or software in the mobile device 100.

An alternative method to position a mobile device may be using short-range positioning beacons. This method is applicable in relatively small areas, such as a single building, but also along frequently visited roads, wherein a local area network can provide locations along with other services. For really short range applications within buildings, appropriately equipped devices can use Bluetooth for short-range positioning. The position data in such systems will be more accurate than in a cellular positioning system, due to the shorter communication range.

The position determined by means of the received positioning information relating to a current position, and the application requested by the user of the mobile device, are used in combination by control unit 150 to select a profile which is position-dependent, and to load and execute the selected application using parameters determined in the selected profile. The profiles may be manually programmed in advance by means of a user interface of mobile device 100, typically a keypad and a display with a menu system. Alternatively, profiles may be stored according to usage. In an embodiment of the latter kind, a profile may be stored when a certain application is launched for the first time in a certain position, which may or may not have been previously visited by the mobile device 100. In the illustrated embodiment of FIG. 1 the profiles are stored in a memory 160 which may be a random access memory (RAM), a read-only memory (ROM) and an erasable programmable read-only memory (EPROM or Flash memory). In an alternative embodiment a dialog is shown to the user informing that a network is available so that the user can possibly launch an application like a browser, email or messaging application.

Each profile is stored in memory 160 together with one or more related settings for different applications, for use by the mobile device 100 in order to set up a connection to a wireless network, such as e an IEEE 802.11 type WLAN, a WiMAX, a HiperLAN, a Bluetooth LAN, or a cellular mobile communications network such as a GPRS network, or a third generation WCDMA network. The mobile device 100 according to the embodiment illustrated in FIG. 1 is able to connect to different wireless networks through the wireless interface units 120,130.

In accordance with an embodiment of the present invention, the mobile device 100 is configured to automatically use the relevant settings for an application in a certain position. This way drainage of the battery 170 of the mobile device is reduced, since the mobile device 100 does not need to continuously run a scanning process in order to search and identify wireless networks.

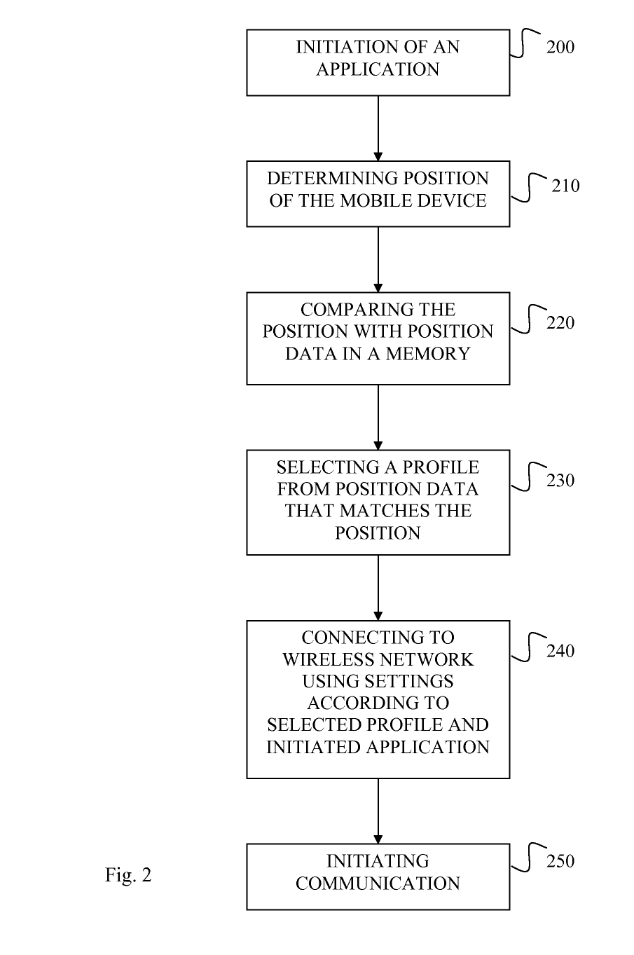

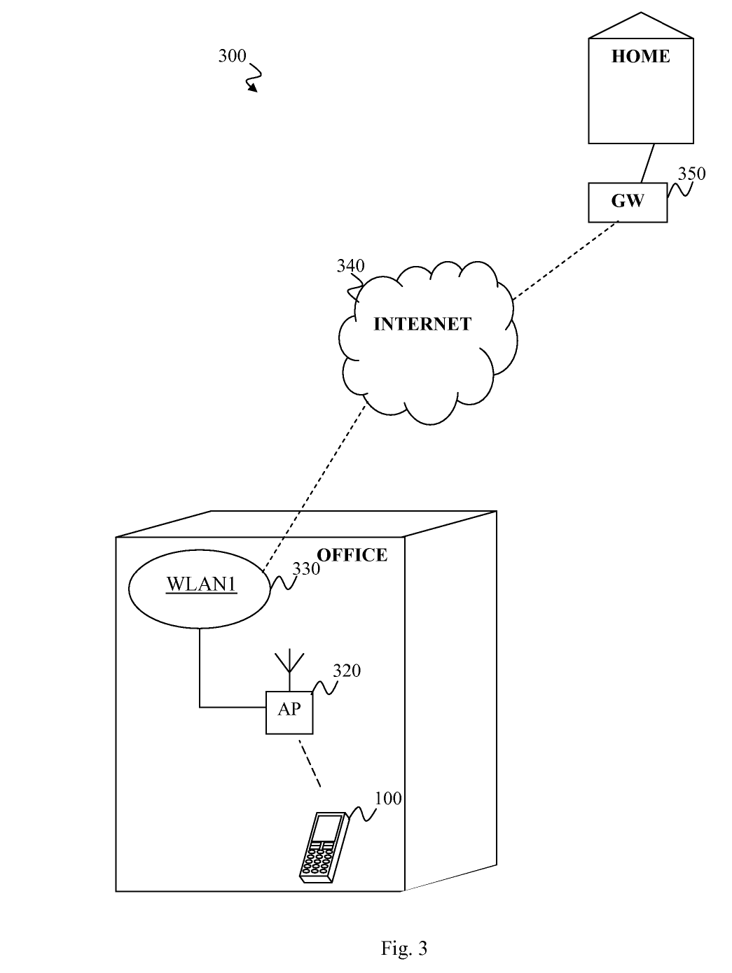

Referring now to FIGS. 2 and 3, the operation of a mobile device 100 in a network 300 is illustrated. A user of mobile device 100 enters a work place for the user, herein referred to as the office. The office may be a building, a floor, a room or the like. The size may be related to the obtainable position accuracy, but even if there are different base stations within the office they may collectively be defined in the profile as one position, i.e. the position of the office. After entering the office the user wants to call home.

The user initiates an application that involves setting up a connection to a communications network, step 200 in FIG. 2. The initiation of the application preferably includes selection in a menu system or activation of an icon in a graphical user interface of mobile device 100. In FIG. 2 the mobile device 100 is illustrated as a mobile phone, which is the best mode known to date for implementation of the present invention. Although not outlined in detail, mobile device 100 therefore includes, in addition to the elements illustrated in FIG. 1, a display, a keypad or a touch-sensitive sheet provided on the display, a speaker and a microphone. Returning to the method of FIG. 2, the application selected by the user is Voice over IP (VoIP).

In step 210 the position of mobile device 100 is determined. In one embodiment this includes receiving cell ID positioning information by means of antenna 110 and signal transceiver 140, through a cellular network covering the office. In a different embodiment the mobile device is positioned using GPS coordinates, where GPS satellite signals form the received positioning information. Alternative methods for positioning the mobile device may be used such as Galileo, Glonass or the like. The position of the device 100 is consequently determined based on the positioning information, where the positioning information may form the position data itself, or the position may be determined by analyzing the received positioning information. The position of the device may be constantly checked and determined or, as in the illustrated embodiment, determined following the selection of an application. In the embodiment of FIG. 2, the positioning information includes the cell ID, whereby the position is determined to be represented by that cell ID.

In step 220 the determined position, i.e. the cell ID, is compared to position data stored in memory 160 of mobile device 100. In one embodiment the position data is stored in memory 160 as a list as described below with reference to FIG. 4.

When a match is found between the determined position established from the received positioning information and the position data contained in memory 160, a profile related to the stored position data containing settings for different application is automatically selected, as denoted 230 in FIG. 2. The profiles may be preprogrammed by the user. In one embodiment, the first time a user initiates an application in an area related to a certain position, the user needs to manually select an application client, security parameters and authentication procedures, or alternatively the application is initiated with a default setting. The user is preferably requested via the graphical user interface to respond whether the settings for the application should be stored in a new profile related to the position in question, which is determined by means of received positioning information. In one embodiment it should also be possible to override the automatic selection of settings based on matching of determined present position with stored position data. This may be obtained by displaying, upon selection of an application in the mobile device 100, a question to the user whether or not to use stored settings. Answer Yes launches the application client linked to the profile in question with the associated stored settings for security and so on. Answer No opens a menu in which the different parameters for launching the application can be selected. Also after such a scenario, i.e. when manual setting is made in a position and for an application which are already linked to each other in an existing profile in memory 160, the existing profile may be amended. Each profile is preferably uniquely identified by the determined position, and in combination with a selected application the settings to be used for launching that application are prescribed in the profile. In case the user wants to store the settings of the application in a new profile, a text description of the profile may be inserted by the user via the GUI. In another embodiment the application settings are stored automatically when an application is used in a position never used before.

When the profile has been selected in step 230, e.g. the profile “Office”, control unit 150 loads the settings prescribed in memory 160 for VoIP in the Office profile, and sets up a connection to an access point 320, as indicated in step 240. Settings used are e.g. VoIP codecs for voice compression, hi and low fidelity settings, authentication procedures such as 802.1x, WPA, WEP, PSK, EAP or the like, email clients and the like. In the illustrated example of FIG. 3 where the user wants to make a VoIP call from mobile device 100, the Office profile contains the VoIP client dictated by the employer and is launched in order to connect to the network. It should be noted, though, that in order to set a connection using a VoIP client WLAN access has to be performed first. In FIG. 3 mobile device 100 uses a VoIP over WLAN 330 application, a so called VoWLAN, which is rapidly increasing in use. The VoIP client connects to a residential gateway GW 350 over IP-network 340, typically the Internet. It should be understood that the PSTN may as well be used using IP PBX and the like to transfer information between IP-networks and PSTN. When the connection is set up the mobile device can communicate with the addressed home VoIP phone, as stated in step 250.

An embodiment of how to store profiles in memory 160 is schematically illustrated in FIG. 4, Memory 160 of mobile device 100 contains a list in which a first column includes position data. In the illustrated example, each position is defined by the cell ID of a cellular communications network. The second column includes an identification of the different profiles related to each position data. Each profile further relates to different settings for different applications, such as WLAN access, VoIP, email and the like. In a preferred embodiment, each combination of profile and application comprises information on prescribed client and security aspects, and these settings are preferably automatically configured by mobile device 100 based on the determined position. If the position of e.g. a phone 100 indicates that it is used at work, a VPN client will automatically try to access the WLAN network at the office and the VoIP client dictated by the employer providing high security will automatically be launched, as stated above, when the user tries to make a VoIP call. The same applies if the user wants to use the email function at the office using mobile device 100. In such a case, mobile device 100 uses a Microsoft outlook client to launch the email application, as prescribed in memory 160. However, if the position instead indicates that mobile device 100 is at home, the Home profile will instead be employed. The Home profile specifies a more simplified authentication, such as WEP (Wired Equivalent Privacy) as illustrated in FIG. 4, which will be used to access the WLAN access point, and a free VoIP client may be specified to be launched when the user tries to make a VoIP call. Furthermore, if the user wants to use the email application a Eudora client will be launched automatically. In the illustrated embodiment of the list in FIG. 4 a profile called public is defined to be a default value. This profile is preferably used when an application is launched at a position not previously stored in list of memory 160. When a user of mobile device 100 containing data stored in memory 160 linked by a list as shown in FIG. 4 starts an application, such as VoIP, in the presence of a public hot spot, and where the cell ID received from the hot spot is not found in the list, mobile device 100 will launch the free VoIP client. It should be noted, though, that in order to set a connection using a VoIP client a WLAN access procedure has to be performed first. For the illustrated embodiment, also the settings for the VPN client may be prescribed for the public profile. However, in another embodiment of the present invention, the setting up of a connection in a position not stored in memory 160 must be performed manually, and the automatic procedure is only performed for positions known from the list.

The foregoing has described the principles, preferred embodiments and modes of operation of the present invention. However, the invention should be regarded as illustrative rather than restrictive, and not as being limited to the particular embodiments discussed above. It should therefore be appreciated that variations may be made in those embodiments by those skilled in the art without departing from the scope of the present invention as defined by the following claims.

What is claimed is:

1. A mobile device wirelessly connectable to a communications network, comprising:
a signal transceiver configured to receive positioning information relating to the position of the mobile device;
a memory for storing a plurality of position data and profiles related to the position data, which profiles comprise parameters usable for connecting to communications networks; and
a control unit configured to compare a current position for the mobile device with stored position data, and to select one of the plurality of profiles to connect to said network if the current position matches stored position data.

2. A mobile device according to claim 1, wherein the parameters of a profile comprise application clients, and the control unit is configured to launch the application client contained in the selected profile.

3. A mobile device according to claim 2, comprising a user interface operable to initiate an application, wherein the control unit is configured to retrieve parameters comprised in the profile related to the initiated application.

4. A mobile device according to claim 2, wherein the application clients include VoIP clients and/or email clients, synchronisation clients, browser clients and the like.

5. A mobile device according to claim 1, wherein the parameters of a profile comprise access parameters.

6. A mobile device according to claim 5, wherein the access parameters include security parameters and authentication procedures.

7. A mobile device according to claim 1, wherein the signal transceiver is configured to receive positioning information from a cellular network.

8. A mobile device according to claim 1, wherein the signal transceiver is configured to receive positioning information from a satellite positioning system_{[29]}.

9. A mobile device according to claim 1, wherein the communications network is a radio communications network.

10. A mobile device according to claim 1, comprising a user interface operable to manually launch an application client for connection to a communications network, wherein the control unit is configured to store a profile in the memory including parameters used for connecting to the communications networks, responsive to manual launching of an application client.

11. A method for setting up a connection between a mobile device and a communications network, comprising:
determining the position of the mobile device;
comparing the determined position with position data stored in the mobile device;
selecting a profile related to position data that matches the determined position; and
connecting to a communications network using parameters related to the selected profile.

12. A method according to claim 11, further comprising:
selecting an application in the mobile device; and wherein the connecting step further comprises launching an application client related to the selected profile and corresponding to the selected application.

13. A method according to claim 12, wherein the application clients include VoIP clients and/or email clients, synchronisation clients, browser clients and the like.

14. A method according to claim 11, wherein the step of determining position comprises receiving positioning information from a cellular network.

15. A method according to claim 11, wherein the step of determining position comprises receiving positioning information from satellite positioning system.

16. A method according to claim 11, wherein the step of connecting further comprises authenticating the connection using a security procedure related to the selected profile.

17. A computer program product for use in a processor system of a mobile device, comprising computer program code executable to:
determine the position of the mobile device;
compare said determined position with position data stored in the mobile device;
select a profile related to stored position data that matches the determined position; and
connect to a communications network using settings related to the selected profile.

18. A computer program product according to claim 17, comprising computer program code executable to:
select an application in the mobile device; and wherein the connecting step further comprises launching an application client related to the selected profile and corresponding to the selected application.

19. A computer program product according to claim 18, wherein the application clients include VoIP clients, email clients_{[210]}, synchronisation clients, browser clients and the like.

20. A computer program product according to claim 17, wherein the step of determining position comprises receiving positioning information from a cellular network.

21. A computer program product according to claim 17, wherein the step of determining position comprises receiving positioning information from satellite positioning system.

22. A computer program product according to claim 17, wherein the step of connecting further comprises authenticating the connection using a security procedure related to the selected profile.
